(19) United States
(12) Patent Application Publication
(10) Pub. No.: US 2014/0327968 A1
(43) Pub. Date: Nov. 6, 2014

(54) SHRINK SLEEVE LENTICULAR MATERIAL

(71) Applicant: National Graphics, Inc., Waukesha, WI (US)

(72) Inventor: Donald R. Krause, Lomira, WI (US)

(73) Assignee: National Graphics, Inc., Waukesha, WI (US)

(21) Appl. No.: 14/268,555

(22) Filed: May 2, 2014

Related U.S. Application Data
(60) Provisional application No. 61/819,783, filed on May 6, 2013.

(51) Int. Cl. G02B 3/00; B65D 23/08; B65D 1/02

(52) U.S. Cl. CPC G02B 3/0037; B65D 1/0215; B65D 23/0878
USPC 359/619; 215/12.2; 156/86

(57) ABSTRACT

A heat shrinkable film is formed with a lenticular lens array oriented and sized so that the film may be formed in a sleeve to shrink with application of heat about a container and provide for lenticular image effects as applied to the container.

### CROSS REFERENCE TO RELATED APPLICATION

This application claims the benefit of U.S. provisional application 61/819,783 filed May 6, 2013 and hereby incorporated by reference.

### BACKGROUND OF THE INVENTION

The present invention relates generally to shrink sleeve labels and more particularly to shrink sleeve labels providing for lenticular images.

### BACKGROUND OF THE INVENTION

Lenticular images provide for animated or 3-D effects by placing a lenticular lens over multiple (2 or more) interlaced images. The lenticular lens selectively displays one of the interleaved images depending on the angle of the viewer. An animated effect is produced by selecting images that represent different “frames” of an animation so that the animation is viewable as one changes the angle of viewing. A 3-D image is produced by selecting images that reproduce the binocular disparity of images viewed at slightly different angles by each eye. The lenticular lens then presents a different image to each of the viewer's eyes to generate a stereographic effect.

The lenticular lens is normally a transparent plastic sheet that includes a set of ribs on a front of the sheet each providing a set of parallel semi-cylindrical lenses each having a line focus on the interlaced images for an anticipated viewing distance. The term “semi-cylindrical lens” is not intended, and does not require a constant curvature radius but should be considered to include all elongate lens shapes that conform in cross-section to cylinders, ellipses, pyramids, trapezoids, parabolas and the like. In one form the semi-cylindrical lens will closely approximate a hemi-cylindrical lens

The interlaced image associated with the lenticular lens is typically printed directly on the flat back surface of the lenticular lens. However, it is also possible to first print the interlaced image to a substrate (e.g., paper, plastic, metal, glass or wood) and then join, for example, using an adhesive, the substrate bearing the image to the lenticular lens (i.e., thereby creating the lenticular image).

The plastic material of a lenticular lens is commonly extruded, cast, calendared or embossed. This latter embossing process employs a precisely made lenticular pattern-forming roller (e.g., an engraved cylinder) having a groove pattern on its outer surface that presses into the plastic the shape of the lenticular lenses. When the groove pattern extends parallel to the axis of the cylinder, the roller may be used to emboss material in a continuous longitudinally-extending web so that lenticules run across or transverse to the length of the web. Such a pattern-forming device can be referred to as a “transverse pattern-forming roller”. U.S. Pat. No. 6,624,946 hereby incorporated by reference, describes a transverse pattern-forming roller used to emboss web material.

The lenticular lenses must ordinarily be manufactured with precise tolerances in order to avoid image problems matched to the interleaved images, for example, “bleed through” where a multiple (more than one) of the interleaved images are visible at one angle at the same time. U.S. Pat. No. 6,060,003 describes special techniques to inhibit distortion in the lenticular pattern as the plastic sheet cools. Distortion of the lenses may adversely affect viewing or “flip” of the images as the image angle changes.

While lenticular images are used in a variety of applications, use of lenticular images for labeling consumer packaging using curved containers, such as cans and bottles, has been largely limited by difficulties attendant to attaching the lenticular images to a curved or irregular surface, such as an hour glass shape, that may be resistant to common adhesive attachment.

### SUMMARY OF THE INVENTION

The present invention provides a lenticular image formed in heat shrinkable material of the type that may be fashioned into a tube and then applied to a container by shrinking the tube around the container. Distortion of the lenticular material in the heat shrinking process may be accommodated by one or more of the mechanisms of: corresponding shrinkage of the interleaved images and the lenticular lenses when the image is printed directly on the rear surface of the lenticular lens sheet, selective placement of image elements to favor low distortion portions of the lenticular lens sheet when applied to the container, embossing the lenses after stretching of the shrink-wrap material, and providing a compensating, pre-distortion to the shape of the lenticular lenses to offset distortions in the shrinking process.

In one embodiment, the invention provides a lenticular heat shrinking material constructed of a polymer sheet pre-processed to contract with the application of heat along a shrinkage axis in the plane of the sheet by at least 20 percent. The polymer sheet has lenticular lenses formed on a front surface of the polymer sheet and adapted to image interleaved images proximate to the rear surface of the polymer sheet opposite the front surface.

It is thus a feature of at least one embodiment of the invention to provide a versatile product labeling and packaging material that may provide for lenticular effects such as animation.

The lenticular lenses may be distorted to image the interleaved images applied to the rear surface after shrinkage of the polymer sheet.

It is thus a feature of at least one embodiment of the invention to address the problem of lens distortion inherent in a shrinking film.

The distortion may reduce a radius of curvature of front surfaces of the lenticular lenses.

It is thus a feature of at least one embodiment of the invention to change the focus of the lenticular lenses so that shrinkage refocuses them onto an image at the rear of the film.

The lenticular lenses may be semi-cylindrical and the axes of the semi-cylindrical lenticular lenses may be perpendicular to the shrinkage axis to shrink substantially to hemi-cylindrical lenses when heat is applied to the polymer sheet.

It is thus a feature of at least one embodiment of the invention to provide an ability to orient the lenses for animation that will be visible to users walking by products positioned on store shelves while accommodating the lens distortion inherent in that orientation.

The lenticular heat shrinking material may further include an ink layer providing interleaved images and applied to a rear surface opposite the front surface and an opaque coating material applied over the ink layer on the rear surface.

It is thus a feature of at least one embodiment of the invention to compensate for registration problems caused by shrinkage by employing inks that may shrink with the polymer sheet applied directly on the rear surface of the polymer sheet.

The polymer sheet may be formed into a cylindrical sleeve having two opposite edges seamed to each other and wherein the axes of the semi-cylindrical lenses are substantially parallel with an axis of the cylindrical sleeve.

It is thus a feature of at least one embodiment of the invention to provide a sleeve that may be used for product packaging.

In an alternative embodiment, the lenticular lenses are substantially hemi-cylindrical and the axes of the hemi-cylindrical lenticular lenses are parallel to the shrinkage axis.

It is thus a feature of at least one embodiment of the invention to address the problem of lens distortion by aligning the lenses with their extent parallel to material shrinkage such as provides reduced affect on the optical properties of the lenses.

These particular objects and advantages may apply to only some embodiments falling within the claims and thus do not define the scope of the invention.

### BRIEF DESCRIPTION OF THE DRAWINGS

FIG. 1 is a view of a container fit within a shrink-wrap sleeve before shrinking of the sleeve showing an enlarged portion of the sleeve with transverse lens orientation;

FIG. 2 is a fragmentary cross-section through the assembly of FIG. 1 showing the lenticular array on the outer surface of the sleeve and the printed layer on the inner surface of the sleeve to abut the outer surface of the container which will receive the sleeve after shrinking;

FIGS. 3a and 3b are simplified side and top views of the shrink sleeve manufacturing line showing the embossment of the shrink-wrap material prior to receipt by a tenter frame;

FIG. 4 is a fragmentary front elevational view of a container having an applied lenticular shrink-wrap showing regions of high and low distortion from a target distortion;

FIG. 5 is a front elevational view of the sleeve of FIG. 1 showing regions of different image selection and interlacing technique to accommodate difference in distortion with respect to a target distortion;

FIG. 6 is a side elevational view of a roller used in the manufacturing line of FIGS. 3 and 4 providing transverse embossment;

FIG. 7 is a figure similar to that of FIG. 6 showing a roller for longitudinal embossment;

FIG. 8 is a figure similar to FIG. 1 showing a longitudinal lens orientation;

FIG. 9 is a cross-section through the lenticular material of FIG. 2 showing lens curvature with a target shrink amount as manufactured;

FIGS. 10a and 10b are figures similar to FIGS. 3a and 3b showing simplified side and top views of the shrink sleeve manufacturing line employing a machine direction stretching of the material instead of a tenter frame.

### DETAILED DESCRIPTION OF THE PREFERRED EMBODIMENT

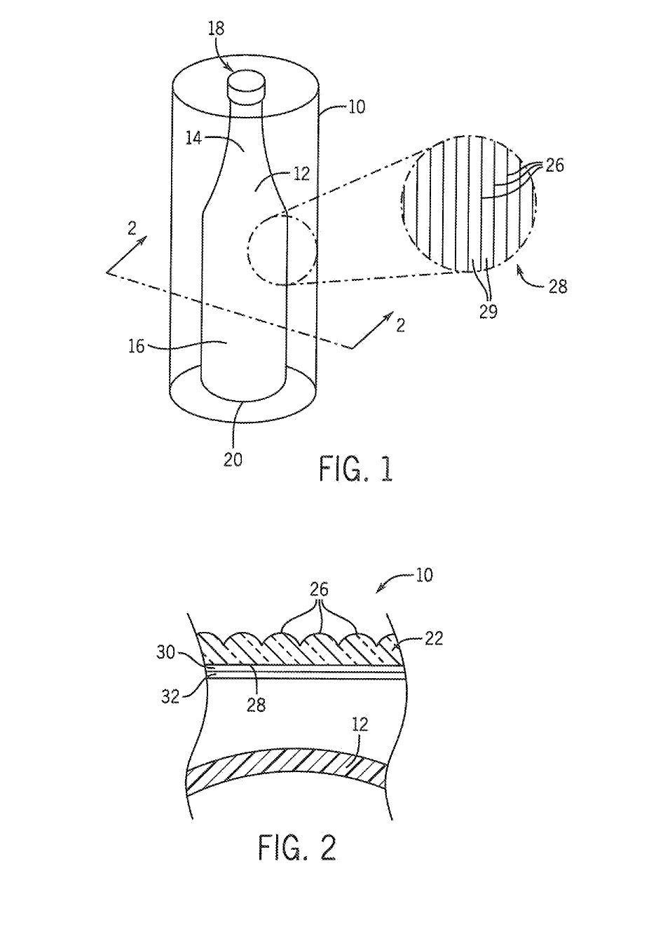

Referring now to FIG. 1, the present invention may provide for a shrink-wrap sleeve 10 that may fit loosely about a container 12 and then be shrunk to conform to the outer container surface using a steam or heat tunnel technique well known in the art.

The container 12 may, for example, have a neck 14 of smaller diameter than a body 16. In this respect, the container may have walls that are neither a simple cylinder nor frustoconical conical shape but, for example, may have a narrowed neck or base that require a curvature of the outer walls along an axis of the wall symmetry. The sleeve 10 may be sized to wrap tightly not only around the neck 14 and body 16 when it is shrunk but also over a top 18 of the neck 14 and over a bottom 20 of the container 12 to both retain the sleeve 10 in the shrunk configuration and to provide tamper resistance as may be desired. The sleeve 10 may include perforations or the like well known in the art allowing it to be removed from the top 18 for access to the product in the container 12 and/or from the entire container 12 for recycling of the container 12. Generally the container 12 will be of a different material than that of the sleeve 10

Referring now also to FIG. 2, in one embodiment the sleeve 10 is a tube constructed of a thin sheet 22 of a transparent and optically clear thermoplastic such as PVC, APET, PETG or the like. An outer surface 24 of the sheet 22 may be embossed with a lenticular lens providing multiple semi-cylindrical lenses 26 whose axes are generally parallel to a central axis of the tube of the sleeve 10 and which have a focal length approximately equal to the thickness of the material. An interlaced image 28 comprised of adjacent image stripes 29 (shown in FIG. 1) may he printed on the rear surface of the sheet 22 in image layer 30 and typically covered within an opaque white ink in a backer layer 32 providing improved reflectivity to the printed interlaced image 28 when viewed through the lenses 26. As is understood in the art, an interlaced image 28 will be comprised of a set of image strips approximately equal in width to a width of the semi-cylindrical lenses 26 where adjacent strips provide portions of different images. Lenticular lenses are well known and commercially available. Methods for using lenticular lens technology are described in detail in U.S. Pat. Nos. 5,113,213; 5,266,995; 5,488,451; 5,617,178; 5,847,808; and 5,896,230 (all of which are incorporated herein by reference).

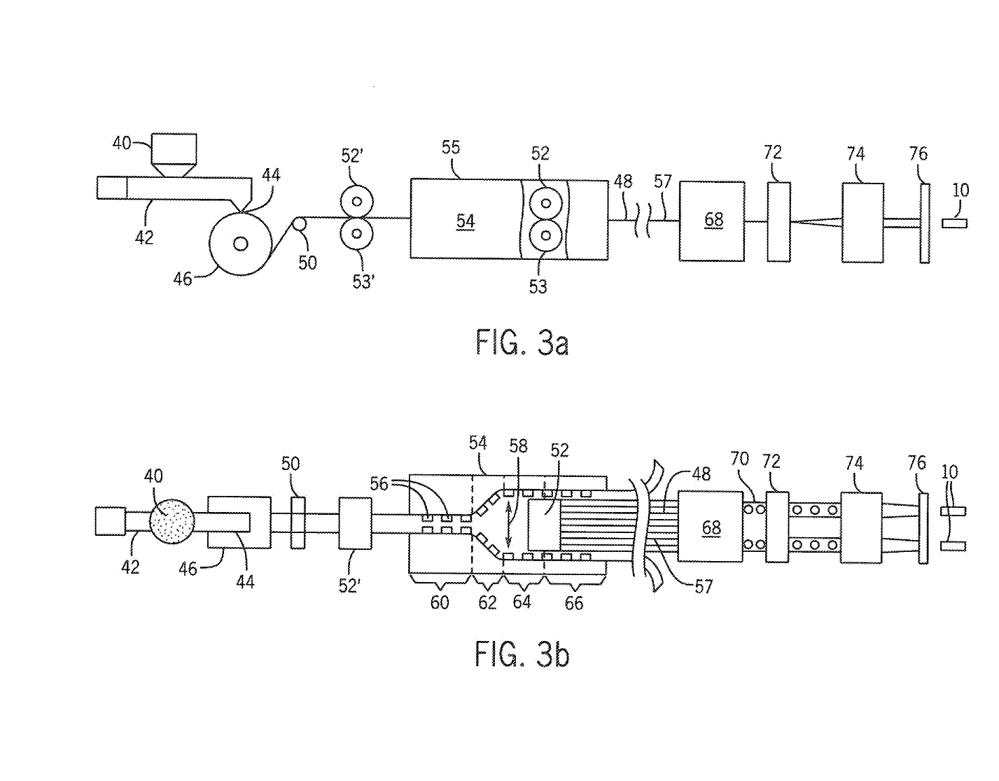

Referring to FIGS. 3a and 3b, in one embodiment, the sheet 22 may be produced by a tenter frame process. In this process, thermoplastic pellets 40 of the appropriate thermoplastic are plasticized and conveyed by an auger 42 to an extruder nozzle 44 adjacent to the outer surface of a rotating chilled roller 46. The extruded molten plastic contacts the roller 46 to coat the roller 46 with a thin plastic sheet. The extruder nozzle may be, for example, a 600 to 1500 mm wide coat hanger slit-nozzle or die for even material flow. The chilled roller 46 may be, for example, partially submerged in a water bath, but more commonly has an internal water-jacketed cooling system.

The surface of the chilled roller 46 is very smooth to provide a substantially flat inner surface free from irregularities. An air knife (not shown) may be used to force proper contact of molten polymer from the nozzle 44 against the chilled roller 46.

A resulting cooled web material 48 proceeds over a tensioning roller 50 and may pass through one or more additional cooling rollers or through a machine direction orientation (MDO) roller set (not shown) imparting a slight stretching to the web material 48 known to improve surface characteristics and which will also provide for heat shrinking capabilities.

Other methods of producing the web material 48 are also contemplated including, for example, a calendaring process in which a billet of semi-molten plastic is gradually flattened and stretched through successive calendaring rollers.

The embossed web material 48 now proceeds to a tenter frame 54 within an oven 55 generally known in the art which provides for a set of clamps 56 (tenter clamps) moving a chain to match the speed of the embossed web material 48. The clamps 56 grab the edges of the web material 48 and stretch the web in a transverse direction 58 as indicated by an arrow as the web material 48 passes through the tenter frame 54. In this process, the web material 48 is first preheated at a preheat stage 60 to a temperature slightly below the melting point of the thermoplastic material. As the web material 48 leaves the preheat stage 60 of the oven, the clamps 56 diverge quite rapidly to a ratio of 8:1 to 10:1 in the stretch stage 62. The web material 48 is then passed on to an annealing area in the oven 55 in an annealing stage 64 where it is maintained at an elevated temperature to reduce the shrinkage of the web material 48.

During the annealing process or slightly before that point but after the stretch stage 62, the web material 48 is received by an embossing roller 52 and a platen roller 53 that clamp the web material 48 between them and together provide the smooth rear surface of the sheet 22 and embossed lenses 26 on the front surface of the sheet 22. Generally the embossed lenses 26 will run in a machine direction perpendicular to the transverse direction 58.

Finally, the web material 48 is cooled to lock in its current expanded dimensions in a cooling stage 66. Edges of the web material 48 where it was clamped are normally trimmed off by rolling knives (not shown) as the web material 48 leaves the tenter frame 54.

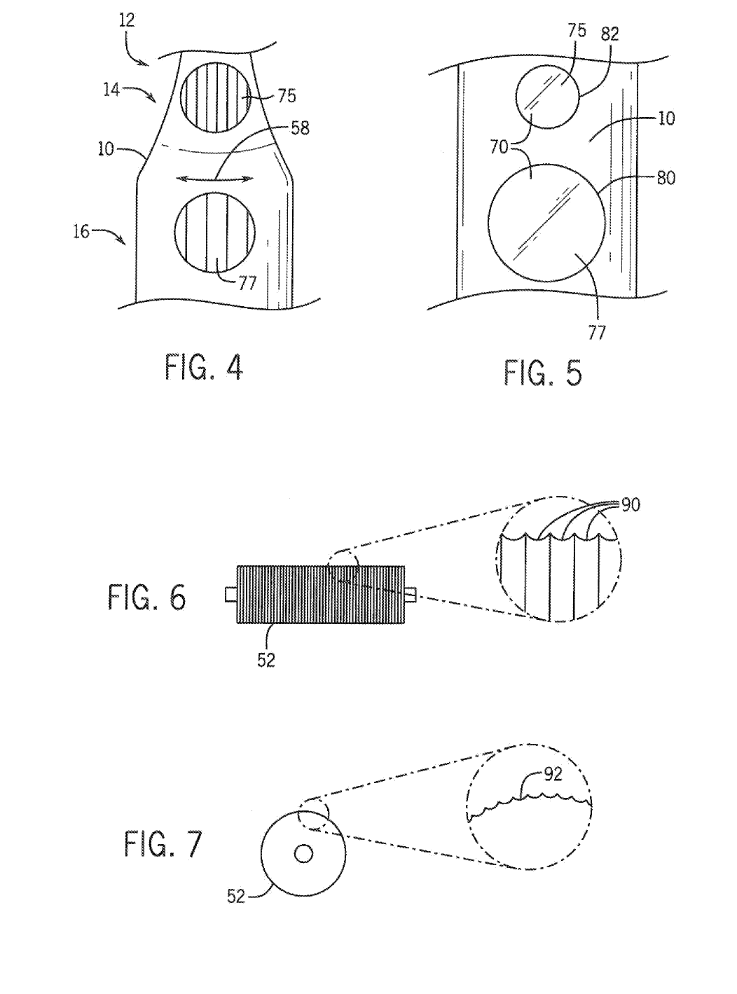

The stretched and embossed web material 57 may then be stored or, as shown, provided to a printer 68 which may print the image layer 30 and white backer layer 32 (shown in FIG. 4) on the flat side of the web material 57 as repeating printed patterns 70. By embossing the web material 48 in its stretched state, being the state in which it will be printed, registration between the printed image and the lenses is ensured even after the shrinking process as will be discussed. At this time perforations may be added to the web material 57.

The web material 57 may then be split into its desired size by rotating knives 73 then rolled and glued into tubes by tube former 74 using techniques known in the art and cut to a length approximating the height of the container 12 by a cutter 76. Resulting sleeves 10 may be stored for future use.

Referring still to FIGS. 3a and 3b, an alternative embodiment of the invention contemplates that an embossing roller 52′ may be positioned upstream from the tenter frame 54 to emboss the web material 48 before stretching by the tenter frame 54. This embodiment may improve the retention of the lens shape in the web material 48 and may provide greater predictability in the lens shape with greater shrinkage of the web material 48 when used with the tenter frame 54, but may raise issues with registration of the printing which is applied only after the web material 48 is stretched. These registration issues may be remedied by an empirical measuring of the amount of stretch in the transverse direction 58 and adjusting the printing process accordingly, for example, using digital printing techniques. In this embodiment, a belt system may be used to press the web material 48 to the embossing roller 52 over a larger portion of the circumference of the embossing roller 52 to provide for better retention of the loop lens shape.

Referring to FIG. 6, for lenticular images that are intended to produce a three-dimensional effect, the embossing roller 52 may provide for a series of circumferential grooves 90 so as to provide for axes of the lenses 26 that lie generally along a length of the web material 48 and perpendicular to the transverse direction 58. This orientation of the lenses 26 will tend to provide the necessary dimensionality or animation effects to a viewer of the ultimate package walking past a shrink-wrapped package when the package is in its normal upright orientation and facilitates the simplest forming of the web material 57 into a sleeve as described above.

Referring now to FIG. 4, in use, the sleeve 10 is slid over the container 12 and heated to a predetermined temperature to cause the sleeve 10 to shrink primarily in the transverse direction 58 to tightly conform to the outer surface of the container 12. Such shrinkage will provide for areas of high distortion 75, for example, around the neck 14 (resulting from substantial shrinkage) and in the transition from the neck 14 to the body 16 (caused by varied shrinkage) and areas of low distortion 77, for example, around the larger sized and constant radius body 16. Generally each of these areas of distortion 75 and 77 may also be assessed with respect to a target distortion being an amount of shrinkage in an area of desired lenticular image placement.

Referring now to FIG. 5, recognizing this difference in distortion allows for positioning of lenticular images 80 where lenticular effects are required in the region of low distortion 77 while providing for non-lenticular images 82 where no lenticular effects or coarse lenticular effects are required, for example, uniform color fills in the regions of high distortion 75. It should be understood that all of the images may have overlying lenses but the “non-lenticular images” 82 are selected to be less important visually or to be images at “key” regions which may not participate in lenticular effects such as dimensionality or animation. Generally in the regions of high distortion 75, the variation between the images of adjacent strips of the interlaced images 28 will be lower than the variation between images of adjacent strips of the interlaced images 28 in the regions of low distortion 75. A constant color over a multi-strip area of the interlaced image 28, for example, would exhibit low variation between images of adjacent strips of the interlaced images 28.

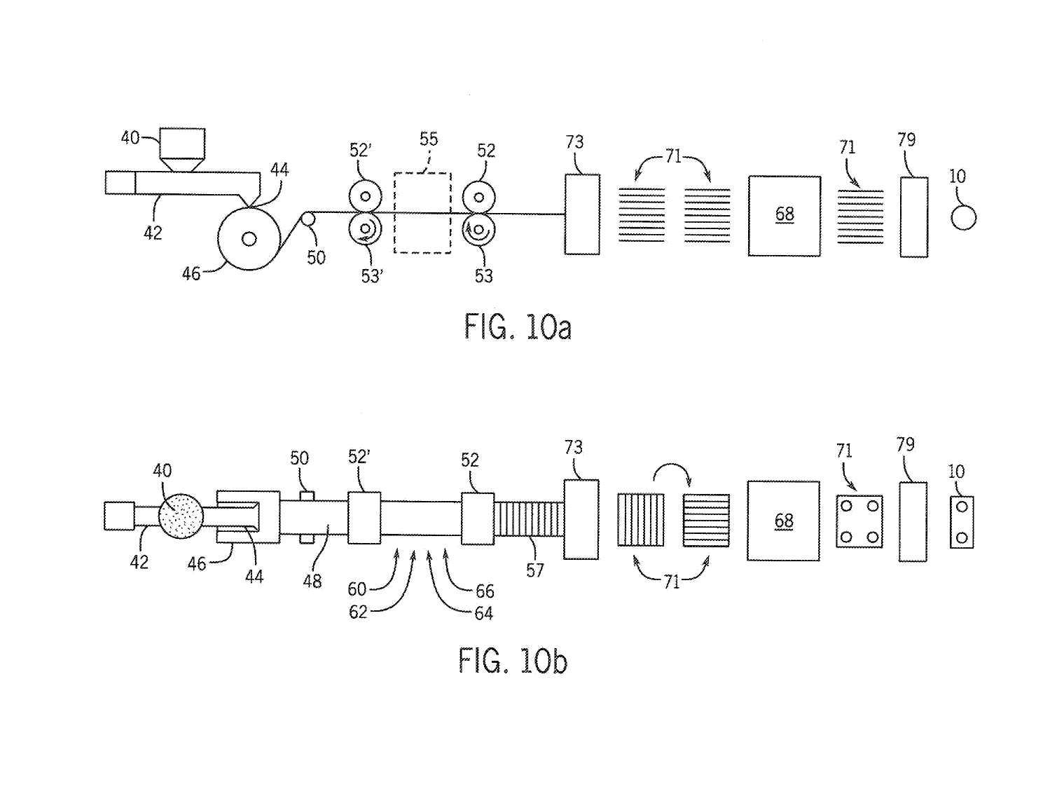

Referring to FIGS. 10a and 10b, in an alternative embodiment, the sheet 22 may be produced by machine direction stretching process. As before, thermoplastic pellets 40 of the appropriate thermoplastic are plasticized and conveyed by an auger 42 to an extruder nozzle 44 adjacent to the outer surface of a rotating chilled roller 46. A resulting cooled web material 48 proceeds over a tensioning roller 50 and may pass through inter-engaging roller 52′ and a roller 53′ that clamp the web material 48 between them and pass it along to second inter-engaging roller 52 and roller 53 moving at a slightly different transfer rate to stretch the web material 48 in the machine direction 49 between them. This area of stretching may be within an oven 55 providing the three zones. As before the first stage may be a preheat stage 60 heating the web material 48 to a temperature slightly below the melting point of the thermoplastic material. As the web material 48 leaves the preheat stage 60 of the oven it stretches under the influence of rollers 52 and 53 rapidly to a ratio of 8:1 to 10:1 in the stretch stage 62. The web material 48 is then passed on to an annealing area in the oven 55 in an annealing stage 64.

Either of the rollers 52′ or 52 may provide for an embossing of lenses 26 on the front surface of the web material 48 with the advantages and disadvantages described above with respect to FIGS. 3a and 3b. In this case the embossing roller 52 or 52′ may provide lenses 26 that extend in the transverse direction 58.

When the embossing of lenses 26 is provided by roller 52′, the shape of the lenses may be compressed slightly in the machine direction and when the embossing of lenses 26 is provided by the roller 52, the shape of the lenses may he expanded slightly in the machine direction to accommodate subsequent expansion and shrinkage as may occur after the embossing up to the time of installation on a container 12.

After leaving the oven 55, the web material 48 is cooled to lock in its current expanded dimensions in a cooling stage 66 and then cut into panels 71 by a rotating knife 73. The panels 72 may be rotated by 90 degrees as indicated by arrow 78 before or after printing by printer 68 and then rolled and seamed into sleeves by forming machine 79 that may operate on panels 71 rather than a continuous web. In this way the orientation of the lenses 26 may be as shown in FIG. 1 and generally aligned with the axis of the sleeve 10.

As shown in FIG. 7, the embossing roller 52 may provide for a series of axial grooves 92 so as to provide for an axis of the lenses 26 that lies generally transversely to the length of the web material 48 and parallel to the transverse direction 58. This orientation is accommodated by forming the shrink-wrap sleeves 10 after rotation so that the axis of the sleeve is aligned with the extent of the lenses 26 and the principal shrinking direction is across the extent of the lenses.

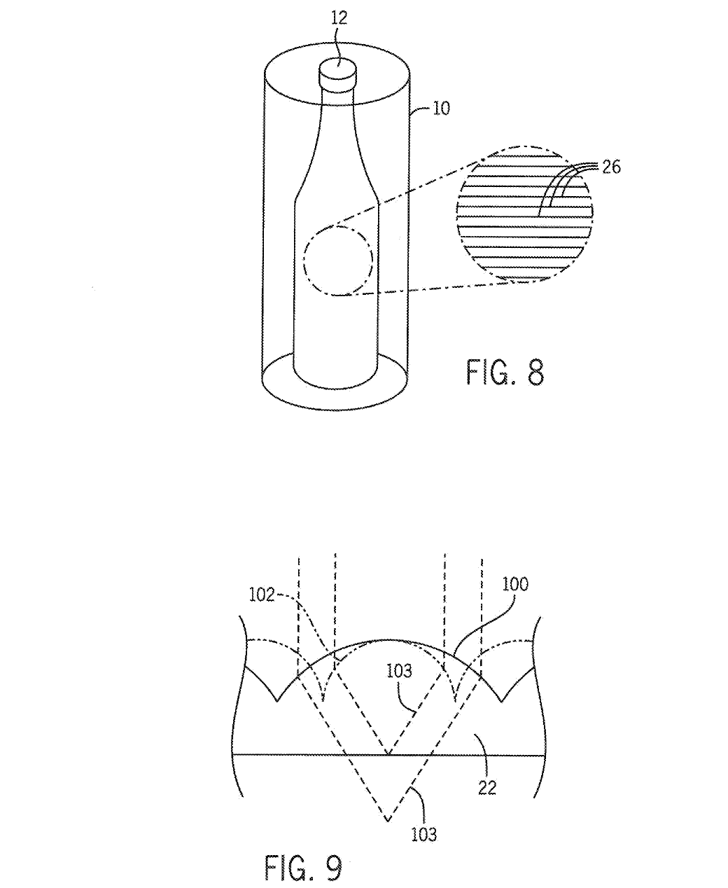

Alternatively, the lenses may be allowed to extend circumferentially around the sleeve 10 to provide for animation effects that occur with movement of the viewer in elevation. This may be done using the machine of either FIGS. 3a and 3b with the roller 52 of FIG. 7 or the machine of FIGS. 10a and 10b using the roller 52 of FIG. 6. Referring now to FIG. 8, in either case, the lenses 26 may extend generally perpendicular to the axis of the sleeve 10. In this case the transverse shrinkage of the sleeve 10 does not affect the profile of the lenses; however, lenses are suitable for animated rather than three-dimensional lenticular displays unless the direction of rolling of the material 48 into sleeves is changed.

Referring now to FIG. 9 the shape of the grooves 90 or 92 in either of the embossing rollers 52, but in particular when used in the configuration shown in FIG. 3, may be geometrically stretched to provide for distorted profile 100 wider than a desired profile 102 by an expected factor of target shrinkage in the vicinity of the region of low target distortion 77 shown in FIG. 4. In this way, the shrinkage may be set to bring the lens profiles into a desired geometric configuration. Conversely, if the net shrinkage is expected after formation of the lenses, the profile 100 may be distorted to be narrower than a desired profile 102. Generally, the distorted profile 100 being wider than the desired profile 102 will provide for a longer focal length 103 whereas the desired profile 102 will provide for focal length 103′ focused approximately on the rear surface of the sheet 22.

In some embodiments, the web material 48 will have a thickness of less than 3.5 mills and 400 lenses per inch. Each may be used to accommodate this thinness suitable for shrink-wrap. The invention contemplates that the lenticular lenses may be spot applied or other lens designs, such as “fisheye” lenses, instead of semi-cylindrical lenses as discussed above.

The invention contemplates that the web material may be formed and the lenticular pattern created by any of extrusion, casting, calendaring, or embossing. The lenticular pattern may be formed either before or after the stretching of the material by properly pre-distorting the lenticular pattern to accommodate subsequent shrinkage. The shrink material may be capable of shrinking greater than 20 percent and typically more than 50 percent with ranges from 60 to 70 percent.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. it is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

I claim:

1. A lenticular heat shrinking material comprising:
a polymer sheet pre-processed to contract with an application of heat along a shrinkage axis in a plane of the sheet by at least 20 percent, the polymer sheet having lenticular lenses formed on a front surface of the polymer sheet and adapted to image interleaved images proximate to a rear surface of the polymer sheet opposite the front surface.

2. The lenticular heat shrinking material of claim 1 wherein the lenticular lenses are distorted to image the interleaved images applied to the rear surface after shrinkage of the polymer sheet.

3. The lenticular heat shrinking material of claim 2 wherein the distortion reduces a radius of curvature of front surfaces of the lenticular lenses.

4. The lenticular heat shrinking material of claim 3 wherein the lenticular lenses are semi-cylindrical and axes of the semi-cylindrical lenticular lenses are perpendicular to the shrinkage axis to shrink substantially to hemi-cylindrical lenses when heat is applied to the polymer sheet.

5. The lenticular heat shrinking material of claim 4 further including an ink layer providing interleaved images and applied to a rear surface opposite the front surface and an opaque coating material applied over the ink layer on the rear surface.

6. The lenticular heat shrinking material of claim 5 wherein the polymer sheet is formed into a cylindrical sleeve having two opposite edges seamed to each other and wherein the axes of the semi-cylindrical lenses are substantially parallel with an axis of the cylindrical sleeve.

7. The lenticular heat shrinking material of claim 6 wherein the polymer film exhibits shrinkage along two perpendicular axes and the shrinkage axis is an axis of greater shrinkage.

8. The lenticular heat shrinking material of claim 7 wherein the polymer sheet is constructed of a transparent thermal polymer selected from the group of PVC, APET, UPS, PLA, PET, PP, PE, PETG, and others.

9. The lenticular heat shrinking material of claim 1 wherein the lenticular lenses are substantially hemi-cylindrical and axes of the hemi-cylindrical lenticular lenses are parallel to the shrinkage axis.

10. The lenticular heat shrinking material of claim 9 further including an ink layer providing interleaved images and applied to a rear surface opposite the front surface and an opaque coating material applied over the ink layer on the rear surface.

11. The lenticular heat shrinking material of claim 5 wherein the polymer sheet is formed into a cylindrical sleeve having two opposite edges seamed to each other and wherein the axes of the semi-cylindrical lenses extend substantially along circumferences of the cylindrical sleeve.

12. A container comprising:
a base having upwardly extending sidewalls terminating at an open neck;
a polymer sleeve conforming at least in part to the upwardly extending sidewalls, the polymer sleeve having lenticular lenses formed on a outer surface of the polymer sleeve and having interleaved images proximate to an inner surface of the polymer sheet opposite the outer surface and adjacent to an outer surface of the upwardly extending sidewalls; and
wherein the upwardly extending sidewalls deviate from a frustoconical shape including a limiting case of a cylinder.

13. The container of claim 12 wherein the base and polymer sleeve are comprised of different materials.

14. The container of claim 13 wherein the upwardly extending sidewalls provide regions of varying sidewall circumference and wherein the interleaved image provides adjacent image stripes with reduced variation between images of the adjacent image stripes in regions of smaller sidewall circumference than in regions of larger sidewall circumference.

15. A method of labeling a product package comprising the steps of
(a) applying a polymer sleeve around a container having a base with upwardly extending sidewalls terminating at an open neck, the polymer sleeve having lenticular lenses formed on a outer surface of the polymer sleeve and having interleaved images proximate to an inner surface of the polymer sheet opposite the outer surface and adjacent to an outer surface of the upwardly extending sidewalls; and
(b) heating the polymer sleeve after installation around the container to shrink the polymer sleeve by varying amounts including by at least 20 percent in some portions to conform to the outer surface of the upwardly extending sidewalls.

16. The method of claim 15 wherein the lenticular lenses are semi-cylindrical and axes of the semi-cylindrical lenticular lenses pass circumferentially around the sleeve.
